(19) United States
(12) Patent Application Publication
(10) Pub. No.: US 2022/0342161 A1
(43) Pub. Date: Oct. 27, 2022

(54) OPTICAL MEASURING DEVICE, ASSEMBLING DEVICE OF MOUNTING SUBSTRATE, AND ASSEMBLING METHOD FOR MOUNTING SUBSTRATE

(71) Applicant: Panasonic Intellectual Property Management Co., Ltd., Osaka (JP)

(72) Inventors: TATSURO SHIRAISHI, Osaka (JP); TOMOTAKA FURUTA, Osaka (JP); JUNICHI KAMATANI, Nara (JP)

(21) Appl. No.: 17/719,447

(22) Filed: Apr. 13, 2022

(30) Foreign Application Priority Data
Apr. 21, 2021 (JP) 2021-071998

(51) Int. Cl. G02B 6/42; G01B 11/24; G01S 17/89; G02B 6/36

(52) U.S. Cl. CPC G02B 6/4236; G01B 11/2441; G01S 17/89; G02B 6/3636

(57) ABSTRACT

An optical measuring device includes: a laser light source that emits first light having a first wavelength; an image capturing unit that emits second light having a second wavelength different from the first wavelength; a separating unit that receives the first light and the second light to direct the first light and the second light toward an object to be measured, and receives reflected light from the object to be measured to separate the reflected light into first reflected light based on the first light and second reflected light based on the second light; a light receiving element that receives the first reflected light separated by the separating unit; and a calculating unit that calculates a yawing angle and a pitching angle of the object to be measured based on a light receiving result of the light receiving element, in which the image capturing unit captures an image of the object to be measured by receiving the second reflected light separated by the separating unit, and the calculating unit calculates a rolling angle of the object to be measured based on an image capturing result acquired by the image capturing unit.

### BACKGROUND

### 1. Technical Field

The present disclosure relates to an optical measuring device, an assembling device of a mounting substrate, and an assembling method for a mounting substrate.

### 2. Description of the Related Art

An autocollimator is known as a device for measuring a minute tilt angle of an object to be measured. The autocollimator irradiates the object to be measured with light and uses a light receiving element to receive reflected light from the object to be measured. The autocollimator can measure the tilt angle of the object to be measured based on a shift amount of a light receiving position of the reflected light on the light receiving element.

The tilt angle of the object to be measured includes a yawing angle, a pitching angle, and a rolling angle, which are angles around three axes orthogonal to each other. The autocollimator cannot measure the rolling angle, which is an angle around an optical axis of irradiation light with respect to the object to be measured.

Japanese Patent Unexamined Publication No. 2010-66090 describes a method for measuring a yawing angle, a pitching angle, and a rolling angle of an object to be measured. Japanese Patent Unexamined Publication No. 2010-66090 describes (a), (b), and (c) matters below.

(a) A measuring body having two reflective members is attached to the object to be measured so as to have two-fold symmetry with respect to an optical axis of light emitted to the object to be measured.

(b) The pitching angle and the yawing angle are measured based on light reflected by one of the reflective members.

(c) The rolling angle is measured based on light passing through one reflective member and reflected by the other reflective member.

### SUMMARY

An optical measuring device according to an aspect of the present disclosure includes: a laser light source that emits first light having a first wavelength; an image capturing unit that emits second light having a second wavelength different from the first wavelength; a separating unit that receives the first light and the second light to direct the first light and the second light toward an object to be measured, and receives reflected light from the object to be measured to separate the reflected light into first reflected light based on the first light and second reflected light based on the second light; a light receiving element that receives the first reflected light separated by the separating unit; and a calculating unit that calculates a yawing angle and a pitching angle of the object to be measured based on a light receiving result of the light receiving element, in which the image capturing unit captures an image of the object to be measured by receiving the second reflected light separated by the separating unit, and the calculating unit calculates a rolling angle of the object to be measured based on an image capturing result acquired by the image capturing unit.

An assembling device of a mounting substrate according to an aspect of the present disclosure includes: a laser light source that emits first light having a first wavelength; an image capturing unit that emits second light having a second wavelength different from the first wavelength; a separating unit that receives the first light and the second light to direct the first light and the second light toward an optical fiber array, and receives reflected light from the optical fiber array to separate the reflected light into first reflected light based on the first light and second reflected light based on the second light; a light receiving element that receives the first reflected light separated by the separating unit; a calculating unit that calculates a yawing angle and a pitching angle of the optical fiber array based on a light receiving result of the light receiving element; an adjusting device that adjusts an attitude of the optical fiber array with respect to a substrate based on a calculation result acquired by the calculating unit; and a fixing device that fixes the optical fiber array to the substrate, in which the image capturing unit captures an image of the optical fiber array by receiving the second reflected light separated by the separating unit, and the calculating unit calculates a rolling angle of the optical fiber array based on an image capturing result acquired by the image capturing unit.

An assembling method for a mounting substrate according to an aspect of the present disclosure includes: a step of irradiating an optical fiber array with first light emitted from a laser light source and having a first wavelength and second light emitted from an image capturing unit and having a second wavelength different from the first wavelength; a step of separating reflected light from the optical fiber array into first reflected light based on the first light and second reflected light based on the second light; a step of receiving the first reflected light with a light receiving element; a step of receiving the second reflected light with the image capturing unit; a step of calculating a yawing angle and a pitching angle of the optical fiber array based on a light receiving result of the first reflected light of the light receiving element; a step of calculating a rolling angle of the optical fiber array based on a light receiving result of the second reflected light of the image capturing unit; a step of adjusting an attitude of the optical fiber array with respect to a substrate based on the calculated yawing angle, the calculated pitching angle, and the calculated rolling angle; and a step of fixing the optical fiber array to the substrate.

### BRIEF DESCRIPTION OF THE DRAWINGS

FIG. 1 is a plan view showing an outline of an optical measuring device according to an embodiment;

FIG. 2 is a plan view illustrating a measurement principle of a yawing angle;

FIG. 3 is a front view of a light receiving element provided in the optical measuring device;

FIG. 4 is a diagram showing an example of an image of an object to be measured generated by capturing with an optical measuring device;

FIG. 5 is a plan view showing an assembling device according to the embodiment;

FIG. 6 is a flowchart showing a procedure for assembling a mounting substrate with the assembling device according to the embodiment;

FIG. 7 is a flowchart showing a procedure for adjusting an attitude of an optical fiber array with the assembling device according to the embodiment; and

FIG. 8 is a side view showing an outline of an optical measuring device disclosed in Japanese Patent Unexamined Publication No. 2010-66090.

### DETAILED DESCRIPTIONS

(Disclosure Content of Japanese Patent Unexamined Publication No. 2010-66090)

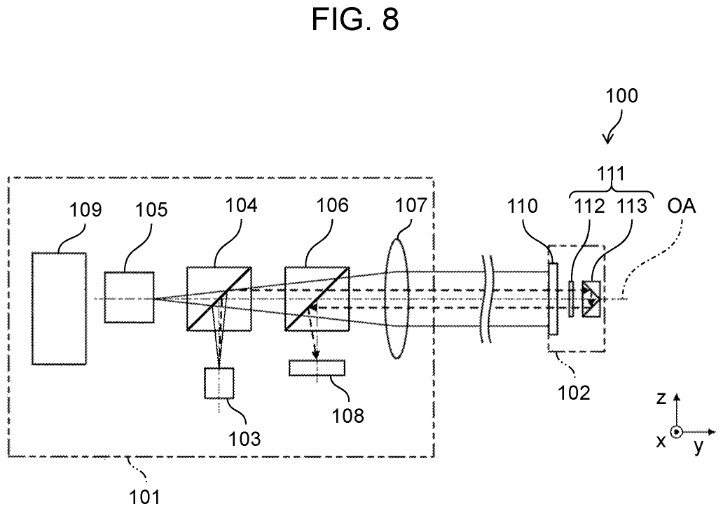

First, optical measuring device 100 disclosed in Japanese Patent Unexamined Publication No. 2010-66090 will be described with reference to FIG. 8. FIG. 8 is a side view showing an outline of optical measuring device 100 disclosed in Japanese Patent Unexamined Publication No. 2010-66090.

Optical measuring device 100 includes device main body 101 and measuring body 102 attached to an object to be measured.

Device main body 101 includes laser light source 103, non-polarizing beam splitter 104, polarizing beam splitter 106, parallelizing lens 107, first light receiving element 105, second light receiving element 108, and calculating unit 109.

Laser light source 103 emits light.

Non-polarizing beam splitter 104 is an element that transmits a part of light and reflects the other part. Non-polarizing beam splitter 104 emits the reflected light toward polarizing beam splitter 106.

Polarizing beam splitter 106 is an optical element that reflects light having a polarization plane orthogonal to a predetermined polarization plane. Since the light reflected by non-polarizing beam splitter 104 is light having the predetermined polarization plane, the light is not reflected and passes through polarizing beam splitter 106.

Parallelizing lens 107 parallelizes the light passing through polarizing beam splitter 106 and emits the light from device main body 101.

First light receiving element 105 receives light reflected from measuring body 102 and passing through polarizing beam splitter 106 and non-polarizing beam splitter 104 (hereinafter, referred to as first measurement light).

Second light receiving element 108 receives the light reflected from measuring body 102 and reflected by polarizing beam splitter 106 (hereinafter, referred to as second measurement light).

Calculating unit 109 calculates a yawing angle and a pitching angle of the object to be measured based on a light receiving result of second light receiving element 108. Calculating unit 109 calculates a rolling angle of the object to be measured based on the light receiving result of second light receiving element 108.

Measuring body 102 is attached to the object to be measured so as to have a two-fold symmetry with respect to optical axis OA of light emitted from device main body 101. Measuring body 102 includes reflection mirror 110 and reflection portion 111.

Reflection mirror 110 reflects a part of the light emitted from device main body 101.

Reflection portion 111 includes quarter wave plate 112 and corner cube 113.

Quarter wave plate 112 emits light toward corner cube 113 while changing a polarization plane of light passing through reflection mirror 110 by 45 degrees. Corner cube 113 reflects light emitted from quarter wave plate 112 and incident on corner cube 113. The reflected light of corner cube 113 is parallel to the light incident on corner cube 113.

As described above, a part of the light emitted from device main body 101 is reflected by reflection mirror 110. Since the part of the light has a predetermined polarization plane, the part of the light passes through polarizing beam splitter 106. A part of the passing light (that is, the first measurement light) passes through non-polarizing beam splitter 104 and is received by first light receiving element 105.

Calculating unit 109 calculates displacement of the yawing angle and the pitching angle of the object to be measured based on displacement of a light receiving position of the first measurement light in first light receiving element 105.

As described above, the other part of the light emitted from device main body 101 passes through reflection mirror 110 and quarter wave plate 112, is reflected by corner cube 113, and again passes through quarter wave plate 112. A polarization plane of the light passing twice through quarter wave plate 112 is orthogonal to a polarization plane of the light emitted from device main body 101. Therefore, the light passing twice through quarter wave plate 112 is reflected by polarizing beam splitter 106. The light reflected by polarizing beam splitter 106 (that is, the second measurement light) is received by second light receiving element 108.

Calculating unit 109 calculates displacement of the rolling angle of the object to be measured based on displacement of a light receiving position of the second measurement light in second light receiving element 108.

However, when a size of the object to be measured is very minute, since the measuring body cannot be attached to the object to be measured, a tilt angle of the object to be measured cannot be measured by using the method of Japanese Patent Unexamined Publication No. 2010-66090.

Specifically, as described above, when measuring the tilt angle of the object to be measured by using optical measuring device 100, it is necessary to attach measuring body 102 to the object to be measured. For example, a size of an optical fiber array that is a member in the field of silicon photonics and bundles one or more optical fibers is about several millimeters square. Optical measuring device 100 cannot measure the tilt angle of the object to be measured so minute that such a measuring body 102 cannot be attached. Therefore, the optical fiber array cannot be mounted in an appropriate attitude with respect to a substrate.

An object of the present disclosure is to provide an optical measuring device capable of measuring three types of tilt angles of a minute-sized object to be measured, an assembling device of a mounting substrate, and an assembling method for a mounting substrate.

As described below, according to the present disclosure, three types of tilt angles of a minute member such as an optical fiber array can be measured, and the optical fiber array can be mounted in an appropriate attitude on a substrate.

### Embodiments

Hereinafter, embodiments of the present disclosure will be described with reference to the drawings. In the following drawings, common components are denoted by the same reference numerals, and descriptions thereof are omitted appropriately.

<Optical Measuring Device>

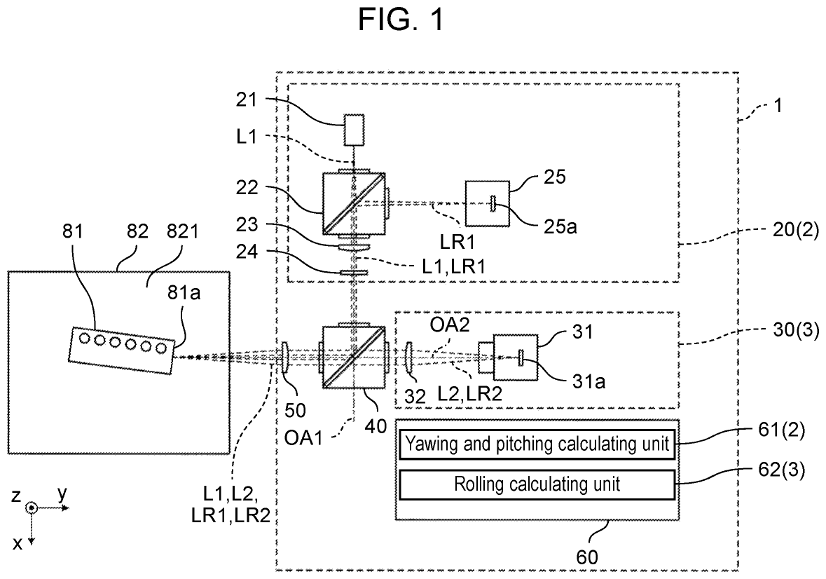

FIG. 1 is a plan view showing an outline of optical measuring device 1 according to an embodiment. Object to be measured 81 is placed on object 82 different from object to be measured 81. Optical measuring device 1 is a device that measures a tilt angle of object to be measured 81.

In the description of the present embodiment, a direction perpendicular to surface 821 of object 82 and away from surface 821 is defined as a positive direction of a z-axis. As shown in FIG. 1, one of two directions constituting a right-handed coordinate system together with the z-axis is a positive direction of an x-axis, and the other is a positive direction of a y-axis. In FIG. 1, a direction from a rear side to a front side is the positive direction of the z-axis, a downward direction is the positive direction of the x-axis, and a right direction is the positive direction of the y-axis.

Optical measuring device 1 includes photodetector device 20, image capturing device 30, separating unit 40, lens 50, and calculating unit 60.

Photodetector device 20 measures data regarding a tilt angle of object to be measured 81 around the z-axis and a tilt angle thereof around the x-axis. As will be described in detail later, in the present embodiment, since an optical axis of light emitted to the object to be measured is along the y-axis, the tilt angle around the z-axis is a yawing angle, the tilt angle around the x-axis is a pitching angle, and the tilt angle around the y-axis is a rolling angle.

Photodetector device 20 includes laser light source 21, polarization separating unit 22, lens 23, wave plate 24, and light receiving element 25.

Laser light source 21 is a laser emitting device that emits first light L1 having a first wavelength. In the present embodiment, first light L1 is linearly polarized light. First light L1 is light other than visible light, for example, infrared light. OA1 in FIG. 1 is an optical axis of first light L1 emitted from laser light source 21.

Polarization separating unit 22 is, for example, a polarizing beam splitter. Polarization separating unit 22 transmits light having a predetermined polarization plane without reflecting the light, and reflects light having a polarization plane orthogonal to the predetermined polarization plane to transmit the light while changing a traveling direction of the light. In the present embodiment, first light L1 has the predetermined polarization plane. Therefore, polarization separating unit 22 transmits first light L1 emitted from laser light source 21 without changing a traveling direction of first light L1.

Meanwhile, polarization separating unit 22 transmits first reflected light LR1 while changing a traveling direction of first reflected light LR1 toward light receiving element 25, first reflected light LR1 being reflected light of object to be measured 81 and being reflected light based on first light L1. A reason why first reflected light LR1 is reflected by polarization separating unit 22 will be described later.

Lens 23 collimates, with parallel light, first light L1 passing through polarization separating unit 22, and collects first reflected light LR1 passing through separating unit 40 and wave plate 24 on light receiving element 25.

Wave plate 24 is a quarter wave plate. Wave plate 24 changes a polarization direction of first light L1 passing through polarization separating unit 22 and lens 23. As a result, first light L1 is converted from linearly polarized light to circularly polarized light. Wave plate 24 changes a polarization direction of first reflected light LR1 passing through separating unit 40. As a result, first reflected light LR1 is converted from circularly polarized light to linearly polarized light. A polarization plane of first reflected light LR1 passing through wave plate 24 is orthogonal to the polarization plane (the predetermined polarization plane described above) of first light L1 before passing through wave plate 24. Therefore, first reflected light LR1 passing through wave plate 24 is reflected by polarization separating unit 22.

Light receiving element 25 includes light receiving sensor 25a. Light receiving element 25 is an element that receives, with light receiving sensor 25a, first reflected light LR1 passing through polarization separating unit 22. Light receiving element 25 may be any element as long as the element can detect a light receiving position of first reflected light LR1. For example, light receiving element 25 is a position sensitive detector (PSD), a charge coupled device (CCD), or a complementary metal-oxide semiconductor (CMOS).

Light receiving element 25 outputs data indicating a light receiving result of first reflected light LR1 of light receiving sensor 25a to calculating unit 60.

Image capturing device 30 is a device that captures an image of object to be measured 81 and object 82. Image capturing device 30 includes image capturing unit 31 and lens 32.

Image capturing unit 31 includes sensor 31a. Image capturing unit 31 is a camera, emits second light L2 having a second wavelength, and captures an image of object to be measured 81 and object 82 by receiving, with sensor 31a, second reflected light LR2 which is a light reflected by object to be measured 81 and is reflected light based on second light L2. Second light L2 has the second wavelength different from the first wavelength of first light L1. Specifically, second light L2 is visible light. OA2 in FIG. 1 is an optical axis of second light L2 emitted from image capturing unit 31.

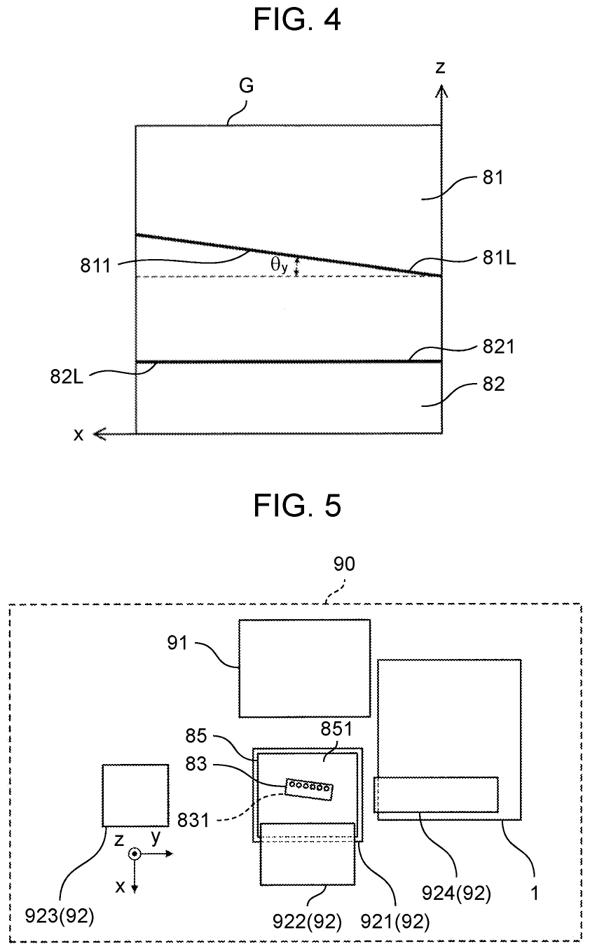

Image capturing unit 31 generates image G (see FIG. 4) in which object to be measured 81 and object 82 are displayed based on a light receiving result of second reflected light LR2, that is, an image capturing result, and outputs image G to calculating unit 60. Image capturing unit 31 may be a CCD camera, a CMOS camera, or the like that can output the image of object to be measured 81 as a two-dimensional signal. In the present embodiment, image G is a still image.

Lens 32 collects second reflected light LR2 passing through separating unit 40 on image capturing unit 31, thereby forming an image of object to be measured 81 and object 82 on sensor 31a of image capturing unit 31.

Separating unit 40 is a dichroic mirror. Separating unit 40 transmits first light L1 while changing the traveling direction of first light L1 and transmits second light L2 without changing a traveling direction of second light L2. As a result, separating unit 40 can guide first light L1 and second light L2 to object to be measured 81.

Separating unit 40 has a characteristic of optically separating light having different wavelengths from each other, and separates the reflected light from object to be measured 81 into first reflected light LR1 and second reflected light LR2.

Separating unit 40 transmits first reflected light LR1 while changing the traveling direction of first reflected light LR1, and transmits second reflected light LR2 without changing a traveling direction of second reflected light LR2.

Lens 50 collects first light L1 and second light L2 passing through separating unit 40 on irradiated surface 81a of object to be measured 81. The optical axis of first light L1 emitted from lens 50 to irradiated surface 81a coincides with the optical axis of second light L2 emitted from lens 50 to object to be measured 81.

Lens 50 guides light reflected by object to be measured 81 to separating unit 40 while converting the light into parallel light. As a result, lens 50 relays the image of object to be measured 81 to lens 32 while collimating the image.

Lens 50 is an aberration correcting lens such as an achromatic lens. Since lens 50 is an aberration correcting lens, chromatic aberration caused by a wavelength difference between first light L1 and second light L2 can be corrected. Lens 50 does not have to be an aberration correcting lens as long as lens 50 can collect first light L1 and second light L2 passing through separating unit 40 on object to be measured 81, and guide the light reflected by object to be measured 81 to separating unit 40.

Calculating unit 60 is a computer including a central processing unit (CPU), a non-volatile memory, and a volatile memory. The CPU reads a predetermined program stored in the non-volatile memory, expands the predetermined program in the volatile memory, and executes the expanded program to function as yawing and pitching calculating unit 61 and rolling calculating unit 62.

Yawing and pitching calculating unit 61 calculates a pitching angle and a yawing angle of object to be measured 81 based on a light receiving result of light receiving element 25.

Rolling calculating unit 62 calculates a rolling angle of object to be measured 81 based on an image capturing result of image capturing unit 31.

Photodetector device 20 described above constitutes yawing and pitching measuring unit 2 together with yawing and pitching calculating unit 61. Image capturing device 30 described above constitutes rolling measuring unit 3 together with rolling calculating unit 62.

<Measurement Performed by Yawing and Pitching Measuring Unit 2>

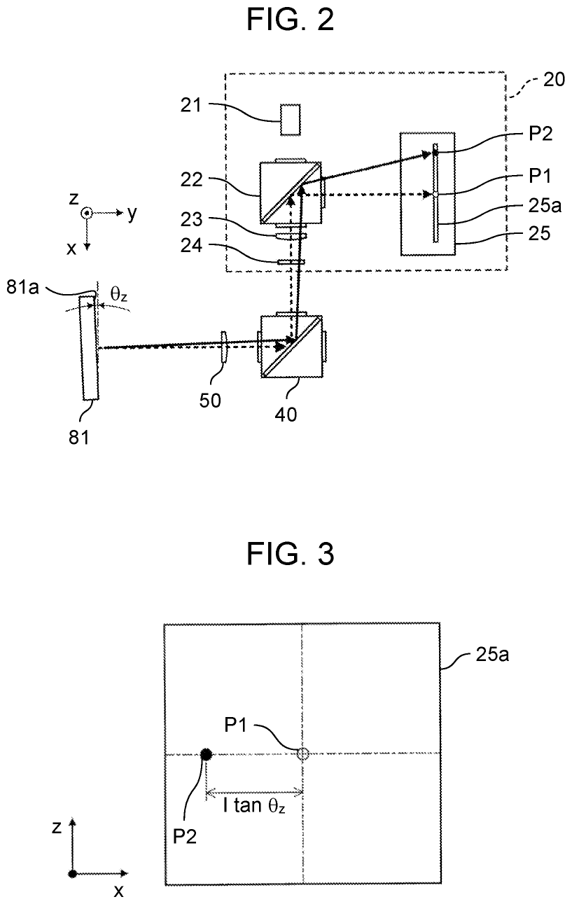

FIG. 2 is a plan view illustrating a measurement principle of the yawing angle. In FIG. 2, an illustration of first light L1 is omitted.

First, a process of irradiating object to be measured 81 with first light L1 will be described. Laser light source 21 emits first light L1. First light L1 passes through polarization separating unit 22 and is collimated by lens 23 so as to be parallel light. Next, first light L1 is converted into circularly polarized light by wave plate 24. Further, first light L1 is reflected by separating unit 40. As a result, first light L1 is emitted toward object to be measured 81 while the traveling direction is changed by 90 degrees. First light L1 emitted from separating unit 40 is collected on irradiated surface 81a of object to be measured 81 by lens 50.

Next, a process in which first reflected light LR1 is received by light receiving element 25 will be described. First reflected light LR1 reflected by irradiated surface 81a of object to be measured 81 is reflected by separating unit 40. As a result, first reflected light LR1 is emitted toward polarization separating unit 22 while the traveling direction is changed by 90 degrees.

First reflected light LR1 emitted from separating unit 40 is converted from circularly polarized light to linearly polarized light by wave plate 24. Here, first reflected light LR1 is converted into light having a polarization plane orthogonal to the polarization plane of first light L1 emitted from laser light source 21.

First reflected light LR1 passing through wave plate 24 passes through lens 23, is reflected by polarization separating unit 22, and is emitted toward light receiving element 25. Light receiving element 25 receives first reflected light LR1 by light receiving sensor 25a.

Hereinafter, a measurement principle of the yawing angle will be described. Hereinafter, it is assumed that the yawing angle of object to be measured 81 is 0 degrees when irradiated surface 81a of object to be measured 81 is perpendicular to the optical axis of first light L1 emitted to object to be measured 81.

When the yawing angle is 0 degrees, as shown by broken line arrows in FIG. 2, first reflected light LR1 is guided to light receiving element 25, and is received at light receiving position P1 of light receiving sensor 25a. Meanwhile, when the yawing angle is Oz degrees, as shown by solid arrows in FIG. 2, first reflected light LR1 is guided to light receiving element 25, and is received at light receiving position P2 of light receiving sensor 25a.

FIG. 3 is a front view of light receiving sensor 25a of light receiving element 25 included in optical measuring device 1.

Light receiving position P2 is shifted in a negative direction of the x-axis with respect to light receiving position P1. In a case where an optical path length of first reflected light LR1 from irradiated surface 81a to light receiving sensor 25a is set to 1 when the yawing angle is 0 degrees, a distance between light receiving position P1 and light receiving position P2 can be approximated by 1 tan θz. Actually, since lens 50 and lens 23 are disposed in the middle of an optical path of first reflected light LR1, a distance between light receiving position P1 and light receiving position P2 may deviate slightly from a value acquired by 1 tan θz.

Light receiving element 25 outputs data on the light receiving position to calculating unit 60. Yawing and pitching calculating unit 61 calculates the yawing angle based on the data on the light receiving position from light receiving element 25 and the above-mentioned formula. Yawing and pitching calculating unit 61 may calculate a yawing angle and a pitching angle of object to be measured 81 with respect to object 82. For example, yawing and pitching calculating unit 61 holds attitude information on an attitude of object 82. Yawing and pitching calculating unit 61 calculates the yawing angle of object to be measured 81 with respect to object 82 based on the calculated yawing angle and the attitude information.

Yawing and pitching measuring unit 2 can calculate the pitching angle in the same manner as the yawing angle.

It is assumed that the pitching angle of object to be measured 81 is 0 degrees when irradiated surface 81a is perpendicular to the optical axis of first light L1 emitted to object to be measured 81, and when the pitching angle is 0 degrees, first reflected light LR1 is received by light receiving sensor 25a at light receiving position P1. When the pitching angle is tilted by θx degrees from 0 degrees, the light receiving position of first reflected light LR1 in light receiving sensor 25a shifts with respect to light receiving position P1 in the positive direction of the z-axis or a negative direction of the z-axis. A shift amount can be approximated by a formula 1 tan θx by using 1, which is the optical path length of first reflected light LR1 from object to be measured 81 to light receiving sensor 25a when the pitching angle is 0 degrees.

In this way, yawing and pitching calculating unit 61 can calculate the pitching angle in the same manner as the yawing angle.

<Measurement Performed by Rolling Measuring Unit 3>

FIG. 4 is a diagram showing an example of image G, captured by optical measuring device 1, of object to be measured 81.

Rolling calculating unit 62 performs image processing on image G. Specifically, rolling calculating unit 62 detects bottom surface 811 of object to be measured 81, and obtains approximation line 81L by linearly approximating a contour of bottom surface 811 in image G based on a detection result. Rolling calculating unit 62 detects surface 821 of object 82, and obtains approximation line 82L by linearly approximating a contour of surface 821 in image G based on the detection result.

Rolling calculating unit 62 calculates a tilt angle of approximation line 81L with respect to approximation line 82L. Accordingly, the rolling angle is determined to be Oy degrees.

<Assembling Device of Mounting Substrate>

Hereinafter, assembling device 90 of a mounting substrate including optical measuring device 1 described above will be described with reference to FIG. 5. FIG. 5 is a plan view showing assembling device 90 according to the embodiment. Reference numeral 83 of FIG. 5 is an optical fiber array. Reference numeral 85 of FIG. 5 is a substrate. An optical circuit having a size of about a dozen millimeters is formed on substrate 85.

Assembling device 90 is a device that fixes optical fiber array 83 to substrate 85 and assembles the mounting substrate.

Assembling device 90 includes optical measuring device 1, adjusting device 91, and fixing device 92.

Optical measuring device 1 is a device that measures attitudes (that is, a yawing angle, a pitching angle, and a rolling angle) of optical fiber array 83 with respect to substrate 85.

Adjusting device 91 holds optical fiber array 83 via a holding member (not shown). Adjusting device 91 is a driving device, and adjusts a position and the attitudes of optical fiber array 83 based on a measurement result acquired by optical measuring device 1.

Fixing device 92 is a device that fixes optical fiber array 83 to substrate 85, and includes stage 921, light receiving device 922, adhesive applying device 923, UV irradiation device 924, and a control device (not shown).

Substrate 85 is fixed to stage 921. Stage 921 is attached to a moving stage (not shown). The moving stage is moved in an xy plane by the control device. Therefore, as the moving stage moves, stage 921, that is, substrate 85 is moved.

Light receiving device 922 includes a light receiving lens (not shown) and a photodetector (not shown). Light receiving device 922 detects, with a photodetector, light emitted from an optical circuit on substrate 85 via light receiving lens to measure energy of the light. The light emitted from the optical circuit is emitted via an optical fiber (not shown) held by optical fiber array 83, is incident on the optical circuit of substrate 85, is guided in the optical circuit, and is emitted from the optical circuit.

Adhesive applying device 923 is a device that applies an adhesive to substrate 85.

UV irradiation device 924 is a device that cures the adhesive by irradiating the adhesive on the substrate 85 with ultraviolet light. UV irradiation device 924 is disposed on an upper side of optical measuring device 1, that is, in the positive direction of the z-axis with respect to optical measuring device 1. That is, UV irradiation device 924 is disposed at a position where the UV irradiation device 924 does not physically interfere with optical measuring device 1.

The control device controls fixing device 92 in general.

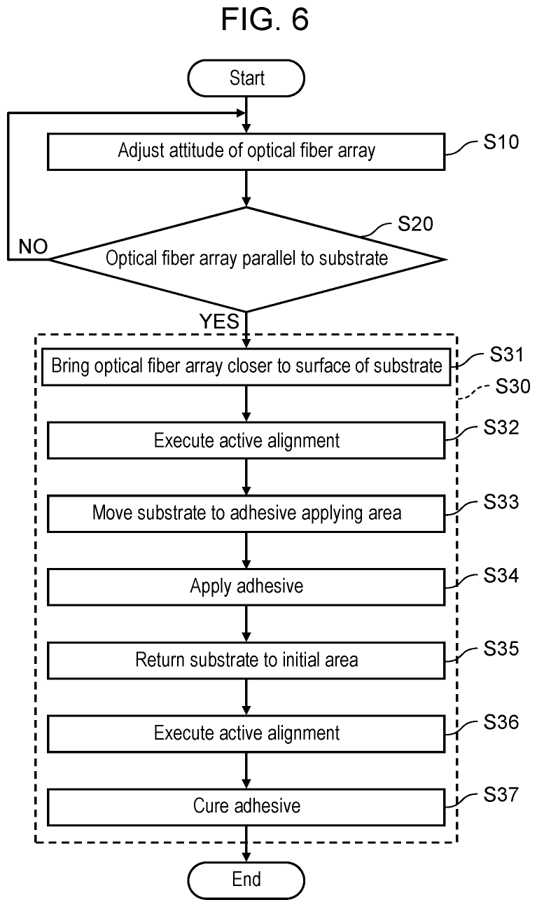

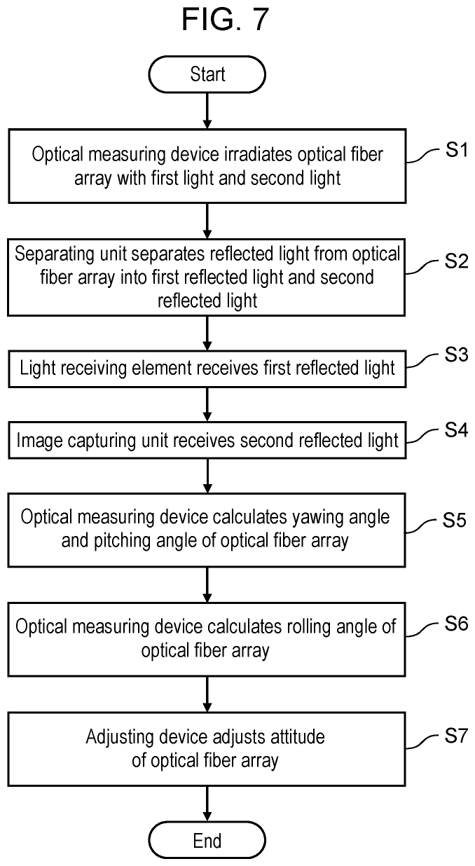

FIG. 6 is a flowchart showing a procedure for assembling the mounting substrate with assembling device 90.

First, adjusting device 91 adjusts the attitudes of optical fiber array 83 with respect to substrate 85 (step S10). At a time of step S10, stage 921 is located in an initial area. When stage 921 is located in the initial area, substrate 85 is located at a position suitable for UV irradiation device 924 to irradiate substrate 85 with ultraviolet light.

Step S10 includes the following steps S1 to S7.

Optical measuring device 1 irradiates optical fiber array 83 with first light L1 emitted from laser light source 21 and second light L2 emitted from image capturing unit 31 (step S1).

Subsequently, separating unit 40 separates reflected light from optical fiber array 83 into first reflected light LR1 and second reflected light LR2 (step S2).

Next, light receiving element 25 receives first reflected light LR1 (step S3).

Then, image capturing unit 31 receives second reflected light LR2 at image capturing unit 31 (step S4). Image capturing unit 31 can capture an image of optical fiber array 83 and substrate 85 by receiving second reflected light LR2 at image capturing unit 31. Image capturing unit 31 generates an image in which optical fiber array 83 and substrate 85 are displayed, and outputs the image to calculating unit 60.

Next, calculating unit 60 of optical measuring device 1 calculates the yawing angle and the pitching angle of optical fiber array 83 with respect to substrate 85 based on the light receiving result acquired by light receiving element 25 (step S5).

Then, optical measuring device 1 calculates the rolling angle of optical fiber array 83 with respect to substrate 85 based on the image capturing result acquired by image capturing unit 31 (step S6). In step S6, calculating unit 60 of optical measuring device 1 calculates a tilt angle of bottom surface 831 of optical fiber array 83 with respect to surface 851 of substrate 85 based on the image output from image capturing unit 31.

Then, adjusting device 91 adjusts the attitudes of optical fiber array 83 with respect to substrate 85 such that bottom surface 831 of optical fiber array 83 is parallel to surface 851 of substrate 85 based on the calculated yawing angle, the calculated pitching angle, and the calculated rolling angle (step S7).

Then, optical measuring device 1 determines whether bottom surface 831 of optical fiber array 83 is parallel to surface 851 of substrate 85 (step S20).

If optical fiber array 83 is not parallel to substrate 85 (NO in step S20), step S10 is executed until optical fiber array 83 is parallel to substrate 85.

If optical fiber array 83 is parallel to substrate 85 (YES in step S20), fixing device 92 fixes optical fiber array 83 to substrate 85 (step S30).

Step S30 includes the following steps S31 to S37.

In step S30, first, adjusting device 91 moves optical fiber array 83 in the negative direction of the z-axis and brings optical fiber array 83 closer to surface 851 of substrate 85 (step S31).

Next, adjusting device 91 and fixing device 92 execute active alignment (step S32). The active alignment is to move optical fiber array 83 to a predetermined position on the xy plane. The predetermined position is a position of optical fiber array 83 in the xy plane where the energy of the light emitted by the optical circuit on substrate 85 is maximized in response to the light emitted to substrate 85 via the optical fiber.

In step S32, first, fixing device 92 emits light via the optical fiber. Then, the light emitted by the optical circuit on substrate 85 is received by light receiving device 922 in response to the light, and an energy of the received light is measured. Next, fixing device 92 searches for a position where the measurement result (that is, the energy of the light) is maximized, while adjusting device 91 scans optical fiber array 83 on the xy plane.

When the active alignment is completed, fixing device 92 moves substrate 85 from the initial area to the vicinity of adhesive applying device 923 (hereinafter, referred to as the adhesive applying area) (step S33). In step S33, fixing device 92 moves the moving stage from the initial area to the adhesive applying area. In step S33, optical fiber array 83 is not moved.

Next, adhesive applying device 923 applies an adhesive to substrate 85 (step S34).

Then, fixing device 92 moves substrate 85 to the initial area (step S35). In step S35, fixing device 92 moves the moving stage from the adhesive applying area to the initial area.

Subsequently, the fixing device 92 executes the active alignment again (step S36). Reason why the active alignment is executed again is that once substrate 85 is moved, a relative position of optical fiber array 83 with respect to substrate 85 shifts.

Next, adhesive applying device 923 irradiates the adhesive on the substrate 85 with ultraviolet light to cure the adhesive (step S37). As a result of the adhesive being cured, optical fiber array 83 is fixed to substrate 85.

The mounting substrate is assembled according to the above process.

As described above, optical measuring device 1 uses first light L1 for measuring the yawing angle and the pitching angle, and uses second light L2 for measuring the rolling angle. Optical measuring device 1 includes separating unit 40 that separates the reflected light from object to be measured 81 into first reflected light LR1 based on first light L1 and second reflected light LR2 based on second light L2. Thus, the three types of the tilt angles of object to be measured 81 can be measured. Optical measuring device 1 calculates the yawing angle based on the image capturing result, acquired by image capturing unit 31, of object to be measured 81. That is, the yawing angle can be measured without attaching a member to object to be measured 81.

Therefore, the three types of the tilt angles of minute-sized object to be measured 81 can be measured. Therefore, assembling device 90 can mount minute-sized optical fiber array 83 on substrate 85 in an appropriate attitude.

Since optical measuring device 1 has separating unit 40, the three types of the tilt angles of object to be measured 81 can be simultaneously measured. Thus, by including optical measuring device 1, assembling device 90 can complete the adjustment of the attitudes of optical fiber array 83 with respect to substrate 85 at an early stage. Therefore, an assembly efficiency of the mounting substrate can be improved.

Image capturing unit 31 generates image Gin which object to be measured 81 and object 82 are displayed, and thus the tilt angle of object to be measured 81 can be calculated with reference to object 82. Thus, the rolling angle of object to be measured 81 can be measured by a simple method.

Since optical measuring device 1 includes lens 50 that collects first light L1 and second light L2 on object to be measured 81, first light L1 and second light L2 are emitted to object to be measured 81 from the same direction. Thus, when the tilt angle of object to be measured 81 is measured, photodetector device 20 and image capturing device 30 can be arranged on the same side with respect to object to be measured 81. Therefore, a degree of freedom in an arrangement position of each device included in assembling device 90 is increased.

For example, when the assembling device has, in addition to the device that measures the yawing angle and the pitching angle, a device that measures the tilt angle by the same principle as that device, as a device that measures the rolling angle, the device that measures the rolling angle will be disposed at a position facing adjusting device 91. In this case, it becomes difficult to secure a disposition space for light receiving device 922.

However, according to the present embodiment, since photodetector device 20 and image capturing device 30 can be arranged on the same side with respect to object to be measured 81, light receiving device 922 can be arranged at a position where the light receiving device 922 faces adjusting device 91.

Photodetector device 20 includes wave plate 24 that changes the polarization direction of first light L1 passing through polarization separating unit 22 and the polarization direction of first reflected light LR1. Therefore, polarization separating unit 22 can change only the traveling direction of first reflected light LR1 of first light L1 and first reflected light LR1. Therefore, photodetector device 20 can measure the yawing angle and the pitching angle by a simple method.

(Modification)

Polarization separating unit 22 may change the traveling direction of one of the first light L1 and the first reflected light LR1 passing through wave plate 24. That is, polarization separating unit 22 may change the traveling direction of first light L1 and may not change the traveling direction of first reflected light LR1. In this case, laser light source 21 is disposed at a position where light receiving element 25 of FIG. 1 is located, and light receiving element 25 is disposed at a position where laser light source 21 of FIG. 1 is located.

Separating unit 40 may change the traveling direction of second light L2. In this case, separating unit 40 changes the traveling direction of second reflected light LR2. Image capturing device 30 is disposed at a position where photodetector device 20 of FIG. 1 is located, and photodetector device 20 is disposed at a position where image capturing device 30 of FIG. 1 is located.

The optical axis of first light L1 emitted from lens 50 to object to be measured 81 does not have to coincide with the optical axis of second light L2 emitted from lens 50 to object to be measured 81, and first light L1 and second light L2 may be applied to object to be measured 81 from the same direction with respect to object to be measured 81.

Image capturing unit 31 may capture an image of only object to be measured 81 without capturing the image of object 82. In that case, for example, image capturing unit 31 has a tilt sensor, and calculating unit 60 may calculate the yawing angle based on the image capturing result for object to be measured 81 while using inclination of image capturing unit 31 as a reference.

Image capturing unit 31 may generate a moving image in real time and output the moving image to the calculating unit 60.

Since second light L2 may have a wavelength different from the wavelength of first light L1, second light L2 does not necessarily have to be visible light. For example, second light L2 may be infrared light and first light L1 may be visible light.

Calculating unit 60 may be divided into a computer that calculates the pitching angle and the yawing angle and a computer that calculates the rolling angle.

The present disclosure can provide the optical measuring device capable of measuring three types of tilt angles of a minute-sized object to be measured, the assembling device of a mounting substrate, and the assembling method for a mounting substrate.

The optical measuring device, the assembling device of a mounting substrate, and the assembling method for a mounting substrate according to the present disclosure can be suitably used for an optical measuring device that measures the tilt angle of the minute-sized object to be measured, an assembling device of a mounting substrate, and an assembling method for a mounting substrate.

What is claimed is:

1. An optical measuring device comprising:
a laser light source configured to emit first light having a first wavelength;
an image capturing unit configured to emit second light having a second wavelength different from the first wavelength;
a separating unit configured to receive the first light and the second light to direct the first light and the second light toward an object to be measured, and receive reflected light from the object to be measured to separate the reflected light into first reflected light based on the first light and second reflected light based on the second light;
a light receiving element configured to receive the first reflected light separated by the separating unit; and
a calculating unit configured to calculate a yawing angle and a pitching angle of the object to be measured based on a light receiving result of the light receiving element,
wherein the image capturing unit captures an image of the object to be measured by receiving the second reflected light separated by the separating unit, and
the calculating unit calculates a rolling angle of the object to be measured based on an image capturing result acquired by the image capturing unit.

2. The optical measuring device according to claim 1,
wherein the image capturing unit generates an image in which the object to be measured and an object different from the object to be measured are displayed, and
the calculating unit calculates the rolling angle of the object to be measured with respect to the object based on the image.

3. The optical measuring device according to claim 1, further comprising:
a lens configured to collect the first light and the second light passing through the separating unit on the object to be measured, and guide the reflected light including the first reflected light and the second reflected light to the separating unit.

4. The optical measuring device according to claim 1,
wherein the separating unit is a dichroic mirror that changes a traveling direction of one of the first light and the second light and does not change a traveling direction of another one of the first light and the second light.

5. The optical measuring device according to claim 1, further comprising:
a polarization separating unit configured to transmit the first light emitted from the laser light source; and
a wave plate configured to change a polarization direction of the first light passing through the polarization separating unit and a polarization direction of the first reflected light,
wherein the polarization separating unit changes a traveling direction of one of the first light and the first reflected light passing through the wave plate, and
the light receiving element receives the first reflected light passing through the polarization separating unit.

6. An assembling device of a mounting substrate, comprising:
a laser light source configured to emit first light having a first wavelength;
an image capturing unit configured to emit second light having a second wavelength different from the first wavelength;
a separating unit configured to receive the first light and the second light to direct the first light and the second light toward an optical fiber array, and receive reflected light from the optical fiber array to separate the reflected light into first reflected light based on the first light and second reflected light based on the second light;
a light receiving element configured to receive the first reflected light separated by the separating unit;
a calculating unit configured to calculate a yawing angle and a pitching angle of the optical fiber array based on a light receiving result of the light receiving element;
an adjusting device configured to adjust an attitude of the optical fiber array with respect to a substrate based on a calculation result acquired by the calculating unit; and
a fixing device configured to fix the optical fiber array to the substrate,
wherein the image capturing unit captures an image of the optical fiber array by receiving the second reflected light separated by the separating unit, and
the calculating unit calculates a rolling angle of the optical fiber array based on an image capturing result acquired by the image capturing unit.

7. The assembling device of a mounting substrate according to claim 6,
wherein the image capturing unit captures an image of the optical fiber array and the substrate, and
the calculating unit calculates a tilt angle of a bottom surface of the optical fiber array with respect to a surface of the substrate based on an image capturing result acquired by the image capturing unit.

8. An assembling method for a mounting substrate, comprising:
a step of irradiating an optical fiber array with first light emitted from a laser light source and having a first wavelength and second light emitted from an image capturing unit and having a second wavelength different from the first wavelength;
a step of separating reflected light from the optical fiber array into first reflected light based on the first light and second reflected light based on the second light;
a step of receiving the first reflected light with a light receiving element;
a step of receiving the second reflected light with the image capturing unit;
a step of calculating a yawing angle and a pitching angle of the optical fiber array based on a light receiving result of the first reflected light of the light receiving element;
a step of calculating a rolling angle of the optical fiber array based on a light receiving result of the second reflected light of the image capturing unit;
a step of adjusting an attitude of the optical fiber array with respect to a substrate based on the calculated yawing angle, the calculated pitching angle, and the calculated rolling angle; and
a step of fixing the optical fiber array to the substrate.
